(19) United States
(12) Patent Application Publication
(10) Pub. No.: US 2007/0020487 A1
(43) Pub. Date: Jan. 25, 2007

(54) Perpendicular recording medium having recording layer with controlled properties and method of manufacturing the perpendicular recording medium

(75) Inventors: Chee-kheng Lim, Yongin-si (KR); No-yeol Park, Seongnam-si (KR); Yong-su Kim, Seoul (KR); Hoon-sang Oh, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/484,692

(22) Filed: Jul. 12, 2006

(30) Foreign Application Priority Data
Jul. 12, 2005 (KR) 10-2005-0062925

(51) Int. Cl. G11B 5/65; B05D 5/12

(52) U.S. Cl. 428/836; 427/127

(57) ABSTRACT

Provided is a perpendicular magnetic recording medium. The perpendicular magnetic recording medium includes: a lower structure; and a recording layer formed on the lower structure, wherein the recording layer has a balancing force 2πMr²/K1 of 0.5 or less and a factor 4πMr/Hc of 0.8 or less where Mr denotes a remnant magnetization, K1 denotes a perpendicular magnetic anisotropy energy constant, and Hc denotes a coercive force. Accordingly, even though grain boundaries between grains that constitute the recording layer are somewhat non-uniform in width, the grains can have almost the same nucleation field. As a result, the perpendicular magnetic recording medium can ensure high recording density and stability of recorded information.

### CROSS-REFERENCE TO RELATED PATENT APPLICATION

This application claims priority from Korean Patent Application No. 10-2005-0062925, filed on Jul. 12, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to a perpendicular magnetic recording medium, and an aspect of the invention relates to a perpendicular magnetic recording medium having a recording layer whose characteristics are controlled to improve information recording density and a method of manufacturing the perpendicular magnetic recording medium.

2. Description of the Related Art

With the recent increasing demand for magnetic recording devices, the demand for magnetic recording media having a high recording density has increased. For conventional magnetic recording media, a longitudinal magnetic recording method in which the magnetization of information is aligned parallel to a recording surface of a disk has been used. However, in order to increase the areal density of magnetic recording media, a perpendicular magnetic recording method has recently been suggested. The perpendicular magnetic recording method can increase recording density by causing magnetization in a direction perpendicular to a recording layer. The recording layer of the perpendicular magnetic recording media is formed of a material having high perpendicular magnetic anisotropy and high coercivity.

FIG. 1 is a schematic view of a conventional perpendicular magnetic recording device.

Referring to FIG. 1, a perpendicular magnetic recording medium 10 includes a substrate (not shown), a soft magnetic underlayer 11, an intermediate layer 13, and a recording layer 15, which are sequentially formed. A protective layer and/or a lubricating layer may be formed on the recording layer 15. Information is recorded by a magnetic head 20 on the perpendicular magnetic recording medium 10 to magnetize the recording layer 15 where the magnetic head is flying at a predetermined distance above the recording layer.

During a write operation, a magnetic flux, which flows from a main pole 21, magnetizes the recording layer 15 in bit regions, passes through a soft magnetic underlayer 12 under the recording layer 15, and returns to a return pole 25 connected to the main pole 21. Since the perpendicular magnetic recording method is superior to a conventional longitudinal magnetic recording method in maintaining the thermal stability of information recorded at high density, the perpendicular magnetic recording method is effective in increasing recording density.

The size of grains in the recording layer and the magnetic recording head of the conventional perpendicular magnetic recording device satisfy some of the conditions for increasing recording density and ensuring the stability of information. However, if the perpendicular magnetic anisotropy energy is not sufficiently large or the grains are not uniform in size or shape, the thermal stability of the recorded information is deteriorated and the lifetime of the information is shortened, thereby making it difficult to ensure stable storage.

### SUMMARY OF THE INVENTION

An aspect of the present invention provides a perpendicular magnetic recording medium, which can improve the stability of information recorded on the medium by enabling all grains to have almost the same nucleation field even though grain boundaries in the grains constituting a recording layer are somewhat non-uniform in thickness and can achieve high-density recording by maintaining a high signal-to-noise ratio, and a method of manufacturing the perpendicular magnetic recording medium.

According to an aspect of the present invention, there is provided a perpendicular magnetic recording medium comprising: a lower structure; and a recording layer formed on the lower structure, wherein the recording layer has a balancing force 2πMr²/K1 of 0.5 or less and a factor 4πMr/Hc of 0.8 or less, where Mr denotes a remnant magnetization, K1 denotes a perpendicular magnetic anisotropy energy constant, and Hc denotes a coercive force.

The recording layer may include at least one selected from the group consisting of FePt, CoPt, FePd, and CoPd.

The recording layer may further include at least one selected from the group consisting of C, Ag, W, Ti, B, Ta, Ru, Cr, Mn, Y, N, O, Pt, Cu, Mn₃Si, Si, Cu, Nb, Ni, Fe, Au, Co, and Zn.

The recording layer may further include at least one selected from the group consisting of Al₂O₃, SiO₂, B₂O₃, C₄F8, Si₃N₄, SiN, BN, ZrO, TaN, and other oxides.

The lower structure may comprise: a substrate; and a seed layer; and an intermediate layer, wherein the seed layer and the intermediate layer are sequentially formed on the substrate.

The perpendicular magnetic recording medium may further comprise a soft magnetic underlayer formed between the seed layer and the intermediate layer.

The intermediate layer and the recording layer may be, as a unit, repeatedly formed in a multi-layered structure.

The recording layer may comprise an additional layer, a first recording layer, and a second recording layer.

The first recording layer may include at least one of Pt and Pd.

The second recording layer may include at least one of Fe and Co.

The additional layer may include at least one selected from the group consisting of C, Ag, W, Ti, B, Ta, Ru, Cr, Mn, Y, N, O, Pt, Cu, Mn₃Si, Si, Cu, Nb, Ni, Fe, Au, Co, and Zn.

The additional layer may include at least one selected from the group consisting of Al₂O₃, SiO₂, B₂O₃, C₄F8, Si₃N₄, SiN, BN, ZrO, TaN, and other oxides.

The additional layer, the first recording layer, and the second recording layer may have a width ranging from 0.1 to 10 nm.

The additional layer, the first recording layer, and the second recording layer may be, as a unit, repeatedly formed in a multi-layered structure.

According to another aspect of the present invention, there is provided a method of manufacturing a perpendicular magnetic recording medium that includes a lower structure and a recording layer formed on the lower structure, the method comprising: when or after the recording layer is formed, performing an annealing process at a temperature from 400 to 700° C. for 1 minute to 2 hours, so that the recording layer can have a balancing force 2πMr2/K1 of 0.5 or less and a factor 4πMr/Hc of 0.8 or less where Mr denotes a remnant magnetization, K1 denotes a perpendicular magnetic anisotropy energy constant, and Hc denotes a coercive force.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional perpendicular magnetic recording medium for explaining a recording method thereof;

FIG. 2A is a graph illustrating a magnetic hysteresis loop of a hard magnetic material used in a recording medium;

FIG. 2B is a graph simplifying the magnetic hysteresis loop of FIG. 2A;

FIG. 3A illustrates grains constituting a perpendicular magnetic recording medium and grain boundaries between the grains;

FIG. 3B is a schematic view for explaining the thickness of the grain boundaries between the grains and magnetostatic energy;

FIG. 4A is a graph illustrating a relation between a nucleation field Hn and a balancing force 2πMr²/K1;

FIG. 4B is a graph illustrating a relation between the balancing force 2πMr²/K1 and a variation of the nucleation field Hn;

FIGS. 5A and 5B are graphs illustrating a relation between the balancing force 2πMr²/K1 and a factor 4πMr/Hc obtained by adding a coercive force Hc, when film widths are 5 nm and 20 nm and grain boundary widths are 0.2 nm and 1.5 nm, respectively;

FIG. 6A is a graph illustrating a relation between a saturation magnetization Ms and the coercive force Hc when materials having a high potential are used for high-density perpendicular magnetic recording media;

FIG. 6B is a graph illustrating a relation between a signal-to-noise ratio and an areal density, that is, the amount of information stored on a given area, when the materials of FIG. 6A are used for high-density perpendicular magnetic recording media; and

FIGS. 7A, 7B, 8A, and 8B are cross-sectional views of the perpendicular magnetic recording media having a balancing force 2πMr²/K1 of 0.5 or less and a factor 4πMr/Hc of 0.8 or less according to embodiments of the present invention.

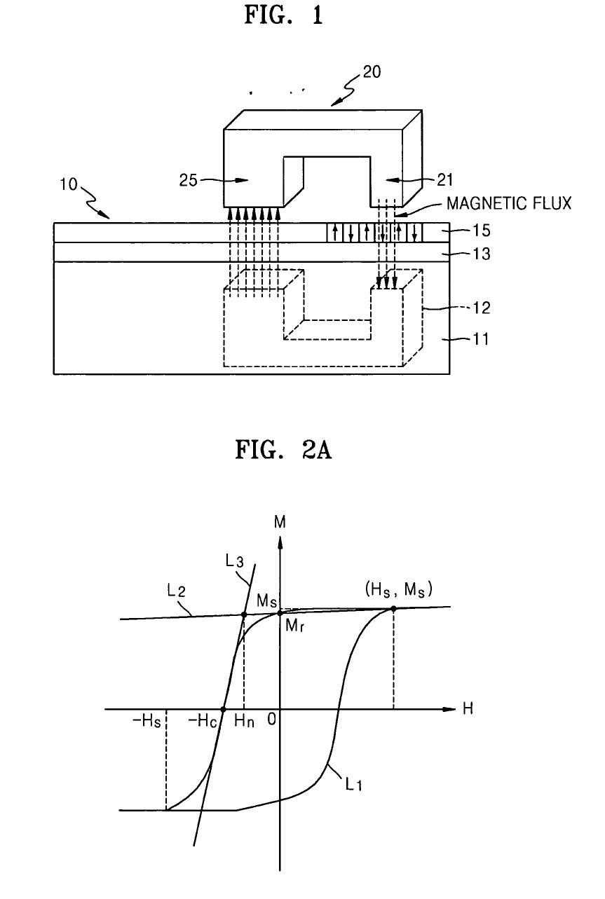

### DETAILED DESCRIPTION OF THE INVENTION

The present invention will now be described more fully with reference to the accompanying drawings, in which exemplary embodiments of the invention are shown.

Perpendicular magnetic recording media according to exemplary embodiments of the present invention are characterized in that 2πMr²/K1≦0.5, 4πMr/Hc≦0.8, 2πMs²/K1≦0.5, and 4πMs/Hc≦0.8 since a remnant magnetization Mr is similar to a saturation magnetization Ms, which will be explained in detail. The unit used for Mr is emu/cm³ and for K1 is erg/cm³

When a perpendicular magnetic recording medium is used, information is recorded on the medium by causing magnetization of grains in a direction perpendicular to a recording layer. In order to realize a perpendicular magnetic recording medium having a high recording density and ensuring long-term stability of recorded information, the following conditions should be satisfied.

First, grains of the perpendicular magnetic recording medium should be small. A grain of a general material is a domain having the same crystal lattice as the other grains. However, a grain in an aspect of the present invention consists of a single magnetic domain where the same magnetization is a result of the large K1 value which keep all the magnetic spin in the same direction. And this direction of spin can be changed by applying an external magnetic field. As described in the Related Art, according to a perpendicular magnetic recording medium, domains having the same spin orientation are represented to unit information, e.g., 0 or 1, of a typical information recording medium. Accordingly, the domains in which the unit information is stored should be small. To this end, grains should be small and an exchange coupling force between the grains should be weak.

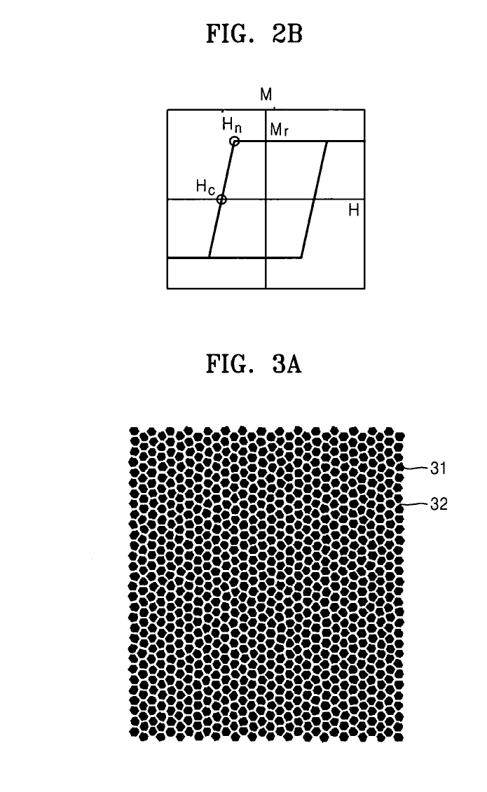

Second, a perpendicular magnetic anisotropy energy constant K1 and a nucleation field Hn of the perpendicular magnetic recording medium should be high to ensure thermal stability. The perpendicular magnetic anisotropy energy constant K1 is directly related to the nucleation field Hn. FIG. 2A is an M-H graph illustrating a magnetic hysteresis loop L1 of a magnetic material. Referring to FIG. 2A, the upper limit of magnetization of the magnetic hysteresis loop L1 of the magnetic material is saturated at a point (Hs, Ms). The magnetic hysteresis loop intersects the Y-axis at (0, Mr). A straight line connecting the point (Hs, Ms) to the point (0, Mr) is denoted L2. A tangent line at point (−Hc, 0) where the magnetic hysteresis loop crosses the negative X-axis is denoted L3. The X-coordinate where the lines L2 and L3 intersect is −Hn. Hn represents a nucleation field and the strength of the nucleation field Hn is dependent on the material and the deposition process. In order to ensure thermal stability of information recorded on the medium, the nucleation field Hn should be high and a variation of the nucleation field Hn due to temperature change or other environmental conditions should be low. FIG. 2B is a simplified version of FIG. 2A using L1, L2, and L3. The graph of FIG. 2B is obtained if the saturation magnetization Ms is similar to the remnant magnetization Mr.

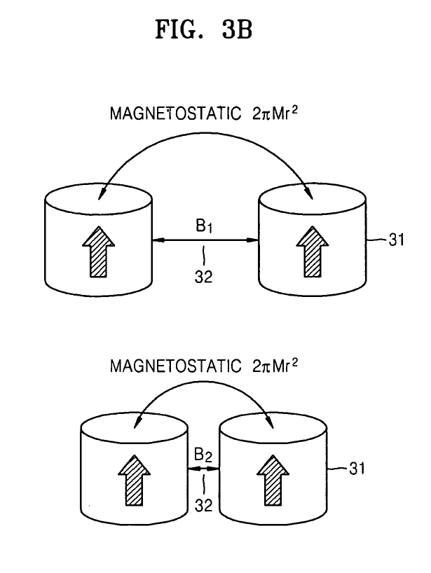

As described above, when the perpendicular magnetic anisotropy energy constant K1 and the nucleation field Hn are high, the perpendicular magnetic recording medium can ensure thermal stability. FIG. 3A illustrates the structure of fine grains of a typical perpendicular magnetic recording medium. Referring to FIG. 3A, a plurality of grains 31 are distributed and grain boundaries 32 are formed between the grains 31. FIG. 3B includes two schematic views illustrating the width of the grain boundaries 32 between the grains 31 and magnetostatic energy. Magnetostatic energy between the grains 31 is dependent on a balancing force 2πMr² of the grains 31 and widths B1 and B2 of the grain boundaries 32. In detail, when the grain boundaries 32 are wide, the magnetostatic energy is weak, and when the grain boundaries 32 are narrow, the magnetostatic energy is strong. The magnetostatic energy and the magnetic anisotropy energy density K1 are related with the nucleation field Hn. To confirm this, a balancing force 2πMr2/K1 including the magnetostatic energy and the magnetic anisotropy energy density K1 is introduced.

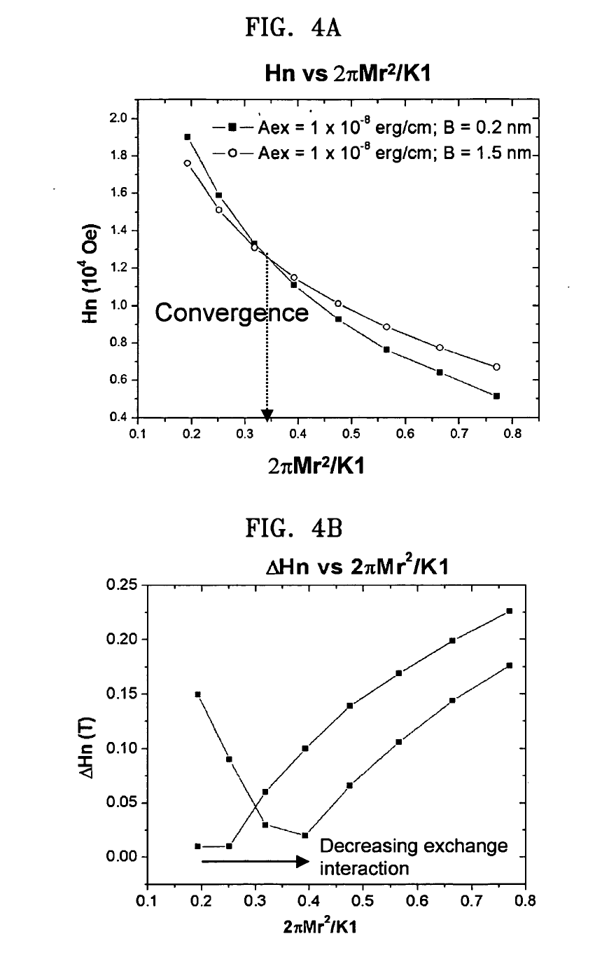

FIG. 4A is a graph illustrating a relation between the nucleation field Hn and the balancing force 2πMr²/K1. In detail, FIG. 4A illustrates the relation between a nucleation field Hn and the balancing force 2πMr²/K1, when a magnetic exchange constant between grains is 10⁻⁸ erg/cm and the grain boundary width is 0.2 nm and when the magnetic exchange constant between grains is 10⁻⁸ erg/cm and a grain boundary width is 1.5 nm.

Referring to FIG. 4A, irrespective of the grain boundary width, the nucleation field Hn increases as the balancing force 2πMr²/K1 decreases. When the balancing force 2πMr²/K1 is approximately 0.35, two curves intersect each other, and when the balancing force 2πMr²/K1 is approximately 0.35, the two curves have the same nucleation field Hn irrespective of the grain boundary width.

FIG. 4B is a plotted graph illustrating a relation between the balancing force 2πMr²/K1 and an absolute variation ΔHn of the nucleation field Hn when the grain boundary widths are 0.2 nm and 1.5 nm.

Referring to FIG. 4B, when exchange interaction between the grains is strong, the variation ΔHn is closer to 0 as the balancing force 2πMr²/K1 is smaller. When exchange interaction between the grains is very weak, the variation ΔHn is closest to 0 at the balancing force 2πMr²/K1 of 0.4 or so. The fact that the variation ΔHn is close to 0 means that almost the same nucleation field Hn is obtained irrespective of the grain boundary width. In other words, almost the same nucleation field Hn is obtained even though the grain boundary width in the medium is non-uniform. That is, whether grain boundaries are locally wide or narrow, almost the same nucleation field Hn is obtained. Thus, the thermal stability of information recorded on the medium can be improved compared to a case where different values of the nucleation field Hn are obtained according to locations.

As described above, in order to realize a high-density perpendicular magnetic recording medium, grains should be small, grain boundaries should be narrow as described with reference to FIG. 4A and a ratio of magnetostatic energy to magnetic anisotropy energy density K1 should be low. To maintain a low variation ΔHn upon a change in grain boundary width, the balancing force 2πMr²/K1 should range within a predetermined limit as described with reference to FIG. 4B. In detail, to allow the variation ΔHn of the nucleation field Hn to be less than 0.15, the balancing force 2πMr²/K1 should be less than 0.5.

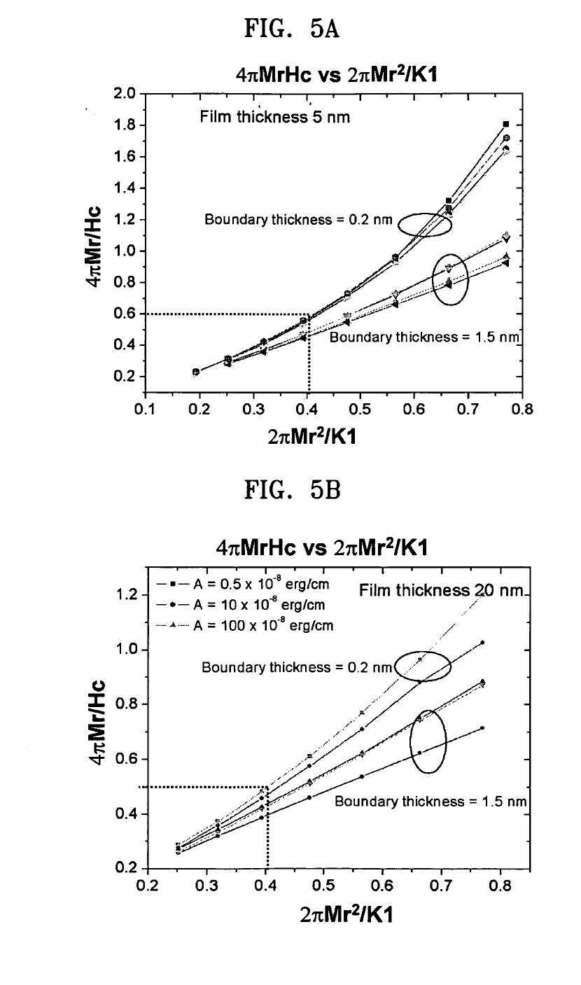

FIGS. 5A and 5B are graphs illustrating the relation between the balancing force 2πMr²/K1 and a factor 4πMr/Hc obtained by adding a coercive force Hc, when film widths are 5 nm and 20 nm and grain boundary widths are 0.2 nm and 1.5 nm, respectively. As can be seen from the M-H graph, the factor 4πMr/Hc is always less than 0.6 when the balancing force 2πMr²/K1 is less than 0.4. The factor 4πMr/Hc is always less than 0.8 when the balancing force 2πMr²/K1 is less than 0.5.

Accordingly, a perpendicular magnetic recording medium according to an aspect of the present invention is characterized in that a magnetic material of a recording layer has a balancing force 2πMr²/K1 of 0.5 or less and a factor 4πMr/Hc of 0.8 or less.

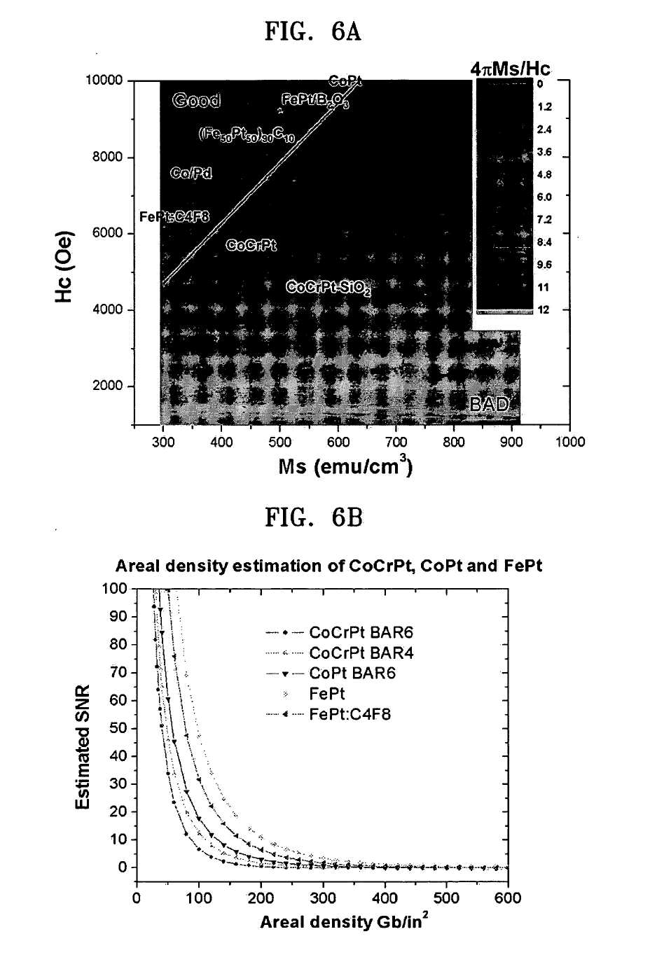

FIG. 6A is a graph illustrating a relation between a saturation magnetization Ms and the coercive force Hc when materials having a high potential are used for high-density perpendicular magnetic recording media. Referring to FIG. 6A, the saturation magnetization Ms and the coercive force Mr of a material used as a recording layer of a perpendicular magnetic recording medium are generally equal to each other. Accordingly, the balancing force 2πMr²/K1 can be used as 2πMs²/K1, and the factor 4πMr/Hc can be used as 4πMs/Hc. Since it is preferable that the factor 4πMs/Hc be less than 0.8, the saturation magnetization Ms should be low and the coercive force Hc should be high. Referring to FIG. 6A, when the characteristics of materials are distributed on the left upper side, the materials are suitable for high-density perpendicular magnetic recording media, and when the characteristics of materials are distributed on the right lower side, the materials are not suitable for the high-density perpendicular magnetic recording media. Accordingly, materials, such as FePt and Co/Pd, are suitable for the high-density perpendicular magnetic recording media.

FIG. 6B is a graph illustrating a relation between the signal-to-noise ratio (SNR) and the areal density when the materials of FIG. 6A are used for high-density perpendicular magnetic recording media. FIGS. 6A and 6B show similar results. For example, FePt and a FePt-based material containing an additive C₄F₈ are more suitable for high-density recording media than other materials because the FePt and FePt-based material have a higher areal density than the other materials when the same SNR is used.

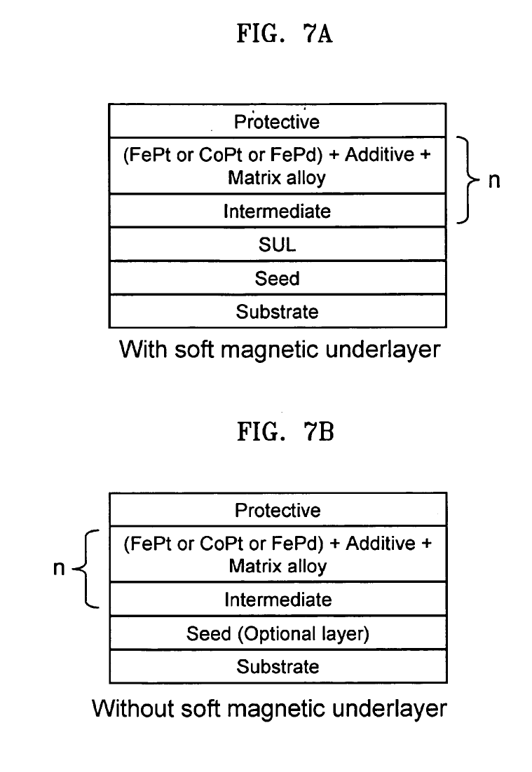

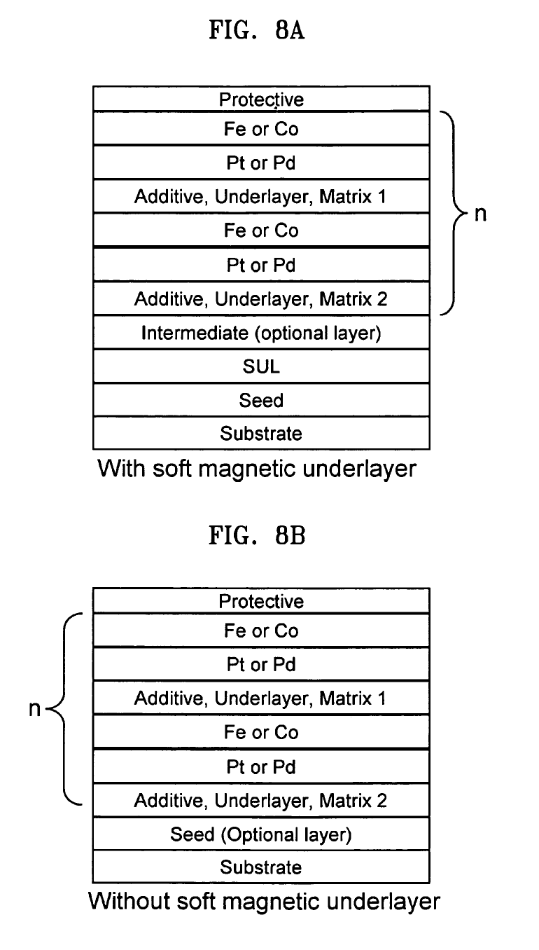

FIGS. 7A, 7B, 8A, and 8B are cross-sectional views of perpendicular magnetic recording media having a balancing force 2πMr²/K1 of 0.5 or less and a factor 4πMr/Hc of 0.8 or less according to exemplary embodiments of the present invention.

In detail, a recording layer is formed on a lower structure. The lower structure includes a substrate, a seed layer, a soft magnetic underlayer (SUL), and an intermediate layer. The recording layer is formed on the lower structure, and a protective layer is selectively formed on the recording layer. The recording layer may be formed of FePt, CoPt, FePd, or CoPd by sputtering a single alloy target or cosputtering several targets, or may be formed in a multi-layered structure such as Fe/Pt, Co/Pt, Fe/Pd, or Co/Pd. The recording layer may selectively include an additive material and a matrix material. In detail, the additive material is selected from the group consisting of C, Ag, W, Ti, B, Ta, Ru, Cr, Mn, Y, N, O, Pt, Cu, Mn₃Si, Si, Cu, Nb, Ni, Fe, Au, Co, and Zn. The matrix material is selected from the group consisting of Al₂O₃, SiO₂, B₂O₃, C₄F8, Si₃N₄, SiN, BN, ZrO, TaN, and other oxides. As described above, to allow the balancing force 2πMr²/K1 to be less than 0.5, an annealing process may be performed in forming the recording layer to increase the magnetic anisotropy energy density K1. When the recording layer is made of FePt, FePd, CoPt, or CoPd, the annealing process may be performed at a temperature from 400 to 700° C. for 1 minute to 2 hours to cause a phase change at a high magnetic anisotropy energy density K1. When the recording layer is formed in a multi-layered structure, each layer may have a thickness of 0.1 to 10 nm and the annealing process is performed at the same condition as it is formed of FePt, FePd, CoPt, or CoPd.

The substrate, the seed layer, the intermediate layer, and the soft magnetic underlayer can consist of other materials. For example, the substrate may be made of glass, and the seed layer may be made of Ta, a Ta alloy, a Ta/Ru compound, or NiFeCr. The intermediate layer may be made of Cu, Ru, Pd, or Pt. The soft magnetic underlayer may be made of a magnetic material such as CoFeB, CoZrNb, CoTaZr, Co₉₀Fe₁₀, or Co₃₅Fe₆₅.

Referring to FIGS. 7A and 7B, the seed layer, the intermediate layer, the recording layer, and the protective layer are sequentially formed on the substrate. While the perpendicular magnetic recording medium of FIG. 7A includes the soft magnetic underlayer, the perpendicular magnetic recording medium of FIG. 7B excludes the soft magnetic underlayer. The intermediate layer and the recording layer may be integrally formed with each other and the integrally formed intermediate layer and recording layer may be repeatedly formed in an n or more multi-layered structure. The recording layer may be formed by adding the additive material and the matrix material to FePt, CoPt, or FePd.

Referring to FIGS. 8A and 8B, the seed layer, an additional layer including the additive material or the matrix material, the recording layer, and the protective layer are sequentially formed on the substrate. While the perpendicular magnetic recording medium of FIG. 8A includes the soft magnetic underlayer and the intermediate layer, the perpendicular magnetic recording medium of FIG. 8B excludes them. The recording layer consists of a first recording layer including at least one of Pt and Pd and a second recording layer including at least one of Fe and Co. An additional layer, a first recording layer, and a second recording layer are newly formed on the second recording layer. As shown in FIGS. 8A and 8B, the additional layer, the first recording layer, and the second recording layer are, as a unit, repeatedly formed in an n or more multi-layered structure. Such a multi-layered structure improves the stability of magnetization perpendicular to the recording layer.

As described above, the perpendicular magnetic recording medium according to an aspect of the present invention has the recording layer with the balancing force 2πMr²/K1 of 0.5 or less and the factor 4πMr/Hc of 0.8 or less when Mr denotes a remnant magnetization, K1 denotes the perpendicular magnetic anisotropy energy constant, and Hc denotes the coercive force. Accordingly, even though the average size of grains constituting the recording layer and the average thickness of grain boundaries between the grains are somewhat non-uniform locally, the grains can have almost the same nucleation field as the other grains, thereby ensuring the stability of recorded information. Also, perpendicular magnetic recording density can be easily controlled by detecting the relation between the nucleation field Hn and the balancing force 2πMr²/K1 or the factor 4πMr/Hc, and detecting specific magnetic conditions for controlling the nucleation field Hn.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording medium comprising:
a lower structure; and
a recording layer formed on the lower structure,
wherein the recording layer has a balancing force 2πMr²/K1 of 0.5 or less and a factor 4πMr/Hc of 0.8 or less, where Mr denotes a remnant magnetization in units of emu/cm³, K1 denotes a perpendicular magnetic anisotropy energy constant in units of erg/cm³, and Hc denotes a coercive force in units of Oersted.

2. The perpendicular magnetic recording medium of claim 1, wherein the recording layer includes at least one selected from the group consisting of FePt, CoPt, FePd, and CoPd.

3. The perpendicular magnetic recording medium of claim 2, wherein the recording layer further includes at least one selected from the group consisting of C, Ag, W, Ti, B, Ta, Ru, Cr, Mn, Y, N, O, Pt, Cu, Mn₃Si, Si, Cu, Nb, Ni, Fe, Au, Co, and Zn.

4. The perpendicular magnetic recording medium of claim 2, wherein the recording layer further includes at least one selected from the group consisting of Al₂O₃, SiO₂, B₂O₃, C₄F8, Si₃N₄, SiN, BN, ZrO, TaN, and other oxides.

5. The perpendicular magnetic recording medium of claim 3, wherein the recording layer further includes at least one selected from the group consisting of A1₂O₃, SiO₂, B₂O₃, C₄F8, Si₃N₄, SiN, BN, ZrO, TaN, and other oxides.

6. The perpendicular magnetic recording medium of claim 1, wherein the lower structure comprises:
a substrate; and
a seed layer; and
an intermediate layer,
wherein the seed layer and the intermediate layer are sequentially formed on the substrate.

7. The perpendicular magnetic recording medium of claim 2, wherein the lower structure comprises:
a substrate; and
a seed layer; and
an intermediate layer,
wherein the seed layer and the intermediate layer are sequentially formed on the substrate.

8. The perpendicular magnetic recording medium of claim 6, further comprising a soft magnetic underlayer formed between the seed layer and the intermediate layer.

9. The perpendicular magnetic recording medium of claim 7, further comprising a soft magnetic underlayer formed between the seed layer and the intermediate layer.

10. The perpendicular magnetic recording medium of claim 6, wherein the intermediate layer and the recording layer are, as a unit, repeatedly formed in a multi-layered structure.

11. The perpendicular magnetic recording medium of claim 7 wherein the intermediate layer and the recording layer are, as a unit, repeatedly formed in a multi-layered structure.

12. The perpendicular magnetic recording medium of claim 1, wherein the recording layer comprises an additional layer, a first recording layer, and a second recording layer.

13. The perpendicular magnetic recording medium of claim 12, wherein the first recording layer includes at least one of Pt and Pd.

14. The perpendicular magnetic recording medium of claim 12, wherein the second recording layer includes at least one of Fe and Co.

15. The perpendicular magnetic recording medium of claim 12, wherein the additional layer includes at least one selected from the group consisting of C, Ag, W, Ti, B, Ta, Ru, Cr, Mn, Y, N, O, Pt, Cu, Mn₃Si, Si, Cu, Nb, Ni, Fe, Au, Co, and Zn.

16. The perpendicular magnetic recording medium of claim 12, wherein the additional layer includes at least one selected from the group consisting of Al₂O₃, SiO₂, B₂O₃, C₄F8, Si₃N₄, SiN, BN, ZrO, TaN.

17. The perpendicular magnetic recording medium of claim 12, wherein the lower structure comprises:
a substrate;
a seed layer; and
an intermediate layer,
wherein the seed layer and the intermediate layer are sequentially formed on the substrate.

18. The perpendicular magnetic recording medium of claim 12, further comprising a soft magnetic underlayer formed between the seed layer and the intermediate layer.

19. The perpendicular magnetic recording medium of claim 12, wherein the additional layer, the first recording layer, and the second recording layer have a width ranging from 0.1 to 10 nm.

20. The perpendicular magnetic recording medium of claim 12, wherein the additional layer, the first recording layer, and the second recording layer are, as a unit, repeatedly formed in a multi-layered structure.

21. A method of manufacturing a perpendicular magnetic recording medium that includes a lower structure and a recording layer formed on the lower structure, the method comprising:
when or after the recording layer is formed, performing an annealing process at a temperature from 400 to 700° C. for 1 minute to 2 hours, so that the recording layer can have a balancing force 2πMr2/K1 of 0.5 or less and a factor 4πMr/Hc of 0.8 or less where Mr denotes a remnant magnetization, L1 denotes a perpendicular magnetic anisotropy energy constant, and Hc denotes a coercive force.

22. The method of claim 21, wherein the recording layer includes at least one selected from the group consisting of FePt, CoPt, FePd, and CoPd.
